(19) United States
(12) Patent Application Publication
(10) Pub. No.: US 2016/0072220 A1
(43) Pub. Date: Mar. 10, 2016

(54) COMMUNICATION CABLE TERMINATION ASSEMBLY, TOOL AND METHOD FOR ASSEMBLING THE SAME

(71) Applicant: TYCO ELECTRONICS (SHANGHAI) CO.LTD., Waigaoqiao Free Trade Zone, Shanghai (CN)

(72) Inventors: Changlong WANG, Shenyang, Liaoning (CN); Jun CHENG, Shanghai (CN); Lei CHEN, Shanghai (CN); Yuanzhe ZHANG, Shanghai (CN); Xindong ZHU, Shanghai (CN)

(21) Appl. No.: 14/783,667

(22) PCT Filed: Mar. 27, 2014
(86) PCT No.: PCT/IB2014/060229

§ 371 Date: Oct. 9, 2015

(30) Foreign Application Priority Data
Apr. 10, 2013 (CN) 2013101223322

(51) Int. Cl. H01R 13/52; H01R 43/00

(52) U.S. Cl. CPC H01R 13/5213; H01R 43/005

(57) ABSTRACT

A communication cable termination assembly, comprising: a communication module (200); and a dust cover (100) capable of being press-fitted onto the communication module (200). A communication cable (300) is fixed on the dust cover (100) and has a cable core (310) disposed between the dust cover (100) and the communication module (200). The communication module (200) comprises a metal piece (203) for electrically connecting to the cable core (310) of the communication cable (300). When the dust cover (100) is press-fitted onto the communication module (200), the metal piece (203) pierces an outer insulation layer of the cable core (310) to electrically contact with an inner conductor of the cable core (310) so as to build an electrical connection between the communication module (200) and the communication cable (300).

### CROSS-REFERENCE TO RELATED APPLICATION

This application claims the benefit of Chinese Patent Application No. 201310122332.2 filed on Apr. 10, 2013 in the State Intellectual Property Office of China, the whole disclosure of which is incorporated herein by reference.

### BACKGROUND OF THE INVENTION

1. Field of the Invention

The present invention relates to a communication cable termination assembly, a tool for assembling the communication cable termination assembly and a method for assembling the communication cable termination assembly.

2. Description of the Related Art

In prior arts, a communication cable is connected to a communication module in advance by, for example, crimping, then a dust cover is assembled onto the communication module.

In the prior arts, during connecting the communication cable to the communication module, it is necessary to provide a special tool for connecting the communication cable to the communication module. Furthermore, after the communication cable is connected to the communication module, an operator must manually press-fit the dust cover onto an end portion of the communication module to fix the dust cover onto the end portion of the communication module.

In the prior arts, the operation of connecting the communication cable to the communication module and the operation of assembling the dust cover to the communication module are performed individually, complicating the assembly work and increasing the assembly time. Moreover, it is necessary to use a special tool to connect the communication cable to the communication module, increasing the cost.

In addition, in the prior arts, since the dust cover is mounted on the communication module after the communication cable has been connected to the communication module, the communication cable may be accidently separated from the communication module during press-fitting the dust cover to the communication module, causing the communication failure.

### SUMMARY OF THE INVENTION

The present invention has been made to overcome or alleviate at least one aspect of the above mentioned disadvantages.

Accordingly, it is an object of the present invention to provide a communication cable termination assembly in which an installation of the dust cover to a communication module and an electrical connection of a communication cable to the communication module can be achieved once by a single step.

Accordingly, it is another object of the present invention to provide a communication cable termination assembly in which the communication cable can be connected to the communication module simply by using the dust cover without needing a special tool.

Accordingly, it is another object of the present invention to provide a communication cable termination assembly in which the communication cable can be reliably connected to the communication module.

According to an aspect of the present invention, there is provided a communication cable termination assembly, comprising:

a communication module; and

a dust cover capable of being press-fitted onto the communication module,

wherein a communication cable is fixed on the dust cover and has a cable core disposed between the dust cover and the communication module,

wherein the communication module comprises a metal piece for electrically connecting to the cable core of the communication cable,

when the dust cover is press-fitted onto the communication module, the metal piece pierces an outer insulation layer of the cable core to electrically contact with an inner conductor of the cable core so as to build an electrical connection between the communication module and the communication cable.

In an exemplary embodiment of the present invention, the dust cover comprising: a cover plate; a cable fixation portion located outside the cover plate; and a first termination portion located inside the cover plate. The communication module comprising a second termination portion located at an end thereof. The first and second termination portions are configured to be capable of being press-fitted together.

In another exemplary embodiment of the present invention, the dust cover has a center hole passing through the cable fixation portion and the cover plate; and the communication cable is introduced into the dust cover through the center hole.

In another exemplary embodiment of the present invention, the cable fixation portion is shaped in a cylindrical boss adapted to be crimped on the communication cable.

In another exemplary embodiment of the present invention, the first termination portion has a cable positioning and clamping feature comprising: a projection wall has a first end proximal to the center hole and a second end opposite to the first end; a positioning slot formed at the first end of the projection wall; and a clamping slot formed at the second end of the projection wall. The cable core introduced into the dust cover through the center hole is positioned in the positioning slot, extends over the top of the projection wall, and is clamped in the clamping slot. The second termination portion comprising a groove into which the projection wall is to be press-fitted.

In another exemplary embodiment of the present invention, the communication cable is a multi-core communication cable comprising a plurality of cable cores; and the first termination portion comprises a plurality of cable positioning and clamping features corresponding to the plurality of cable cores, respectively.

In another exemplary embodiment of the present invention, the plurality of cable positioning and clamping features are symmetrically arranged at both sides of the center hole; the positioning slot is formed in a first protrusion wall substantially perpendicular to the projection wall at the first end; and the clamping slot is formed in a second protrusion wall substantially perpendicular to the projection wall at the second end.

In another exemplary embodiment of the present invention, the outer insulation layers of the plurality of cable cores have different colors from one another; and a vision mark portion is formed on an outer surface of the cover plate and has a plurality of color marking sections corresponding to the colors of outer insulation layers of the plurality of cable cores, the plurality of color marking sections are positioned at positions corresponding to the plurality of cable positioning and clamping features, respectively.

In another exemplary embodiment of the present invention, a notch is formed in the projection wall of the first termination portion; the metal piece is formed in the groove of the second termination portion and corresponds to the notch; and when the projection wall of the first termination portion is press-fitted into the groove of the second termination portion, a tip of the metal piece moves toward the notch and pierces the outer insulation layer of the cable core.

In another exemplary embodiment of the present invention, the first termination portion further comprises a hook, and the second termination portion further comprises a recess for matching with the hook; and when the first termination portion is press-fitted onto the second termination portion, the hook is snapped into the recess to lock the first and second termination portions together.

In another exemplary embodiment of the present invention, the second termination portion comprises two rows of projection vertical walls; and the groove is defined between two adjacent vertical walls.

In another exemplary embodiment of the present invention, the vertical walls of the second termination portion are configured to be received in recesses defined among the projection walls and the first and second protrusion walls of the first termination portion.

In another exemplary embodiment of the present invention, the first termination portion further comprises a guide wall substantially perpendicular to the first protrusion walls; and the second termination portion further comprises a guide groove between the two rows of vertical walls, the guide groove is configured to match with the guide wall so as to guide the first termination portion to be correctly press-fitted onto the second termination portion.

According to another aspect of the present invention, there is provided a tool for press-fitting the dust cover onto the communication module of the communication cable termination assembly according to the above embodiments.

In an exemplary embodiment of the present invention, the tool comprising: a base plate having a first end and a second end opposite to the first end; a handle having an arc end portion rotatably connected to the first end of the base plate; and a block portion formed on the second end of the base plate and having a channel passing therethrough. After being pre-aligned, the dust cover and the communication module are placed on the base plate between the arc end portion and the block portion with the communication cable passing through the channel of the block portion. The arc end portion pushes against the communication module until the dust cover and the communication module are press-fitted together by rotating the handle.

In another exemplary embodiment of the present invention, a plurality of vertical reinforcing ribs are formed on the outer surface of the dust cover, the plurality of vertical reinforcing ribs surrounding and connected to the cable fixation portion; and the block portion of the tool presses against the vertical reinforcing ribs of the dust cover during press-fitting the dust cover and the communication module.

According to another aspect of the present invention, there is provided a method for assembling the communication cable termination assembly according to the above embodiments, comprising steps of:

introducing the communication cable into the dust cover and fixing the communication cable to the dust cover;

positioning the cable cores on the dust cover;

pre-aligning the dust cover and the communication module;

placing the pre-aligned dust cover and communication module in a tool; and

operating the tool to press-fit the dust cover onto the communication module.

In an exemplary embodiment of the present invention, the method further comprising: trimming off end parts of the cable cores extending beyond the dust cover after press-fitting the dust cover onto the communication module.

In another exemplary embodiment of the present invention, the tool is defined by the above embodiments.

In the above various embodiments of the present invention, the installation of the dust cover to the communication module and the electrical connection of the communication cable to the communication module can be achieved once by a single step. Accordingly, it simplifies the assembly work and improves the assembly efficiency of the communication module. Furthermore, it does not need to use a special tool to terminate the communication cable to the communication module, reducing the cost. Moreover, it can ensure a stable electrical connection of the communication cable to the communication module, improving the stability of the Network wiring.

### BRIEF DESCRIPTION OF THE DRAWINGS

The above and other features of the present invention will become more apparent by describing in detail exemplary embodiments thereof with reference to the accompanying drawings, in which:

FIG. 1 is an illustrative perspective view of a dust cover of a communication cable termination assembly according to an exemplary embodiment of the present invention;

FIG. 2 is an illustrative view showing a termination portion inside the dust cover of FIG. 1;

FIG. 3 is an illustrative view showing that cable cores of a communication cable are positioned in the termination portion of the dust cover of FIG. 2;

FIG. 4 is an illustrative perspective view of a communication module of a communication cable termination assembly according to an exemplary embodiment of the present invention;

FIG. 5 is an illustrative perspective view showing that the dust cover of FIG. 3 is pre-aligned and pre-assembled to the communication module of FIG. 4;

FIG. 6 is an illustrative perspective view of a tool for press-fitting the dust cover onto the communication module;

FIG. 7 is an illustrative view showing that the pre-aligned dust cover and communication module are placed in the tool of FIG. 6;

FIG. 8 is an illustrative view showing that the dust cover and the communication module are press-fitted together by operating the tool of FIG. 6; and

FIG. 9 is an illustrative perspective view of the press-fitted communication cable termination assembly of FIG. 8.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In a general concept of the present invention, there is provided a communication cable termination assembly, comprising: a communication module 200; and a dust cover 100 capable of being press-fitted onto the communication module 200. A communication cable 300 is fixed on the dust cover 100 and has at least one cable cores 310 disposed between the dust cover 100 and the communication module 200. The communication module 200 comprises at least one metal pieces 203 for electrically connecting to the cable cores 310 of the communication cable 300, respectively. When the dust cover 100 is press-fitted onto the communication module 200, the metal pieces 203 each pierces an outer insulation layer of the cable core 310 to electrically contact with an inner conductor of one respective cable core 310 so as to build an electrical connection between the communication module 200 and the communication cable 300.

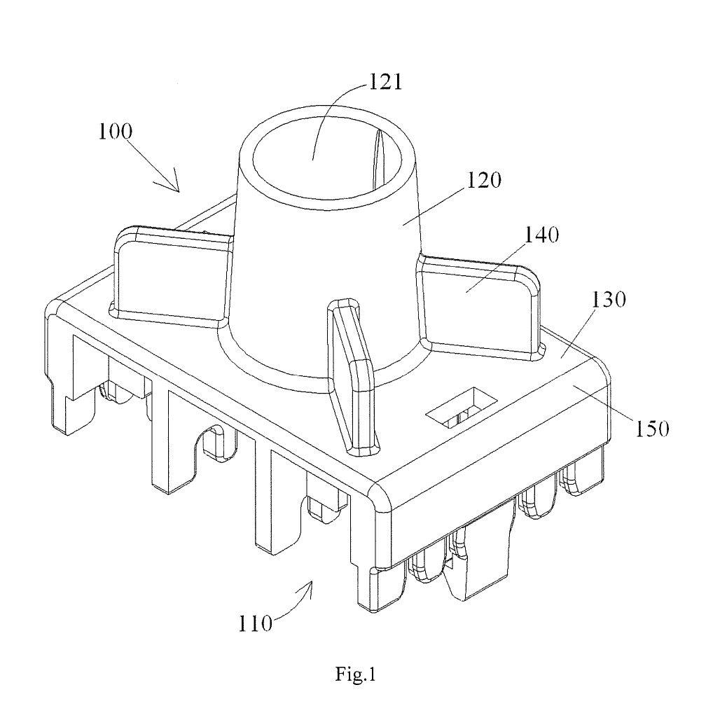

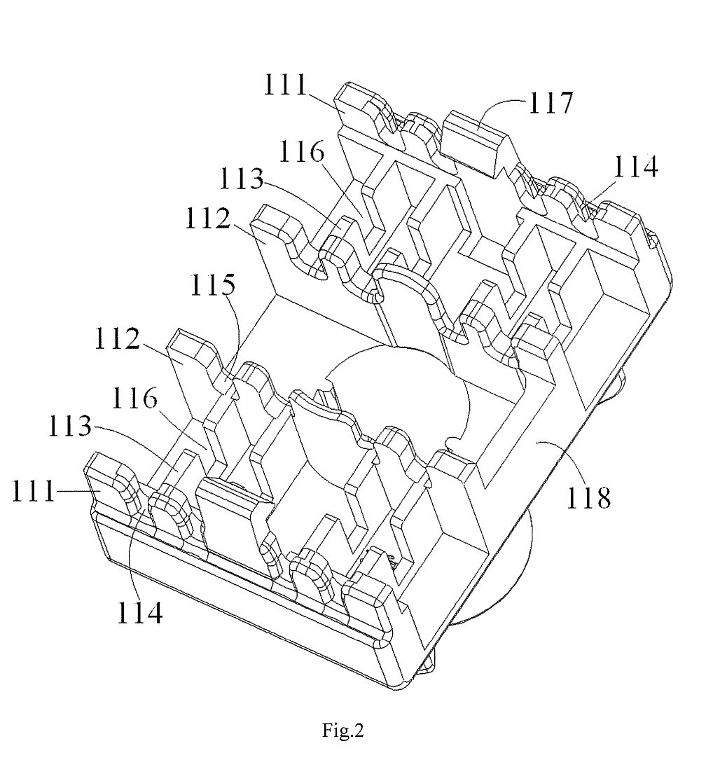

FIG. 1 is an illustrative perspective view of a dust cover 100 of a communication cable termination assembly according to an exemplary embodiment of the present invention; FIG. 2 is an illustrative view showing a termination portion 110 inside the dust cover 100 of FIG. 1.

As shown in FIGS. 1-2, the dust cover 100 mainly comprises a cover plate 130, a cable fixation portion 120 located outside the cover plate 130, and a first termination portion 110 located inside the cover plate 130.

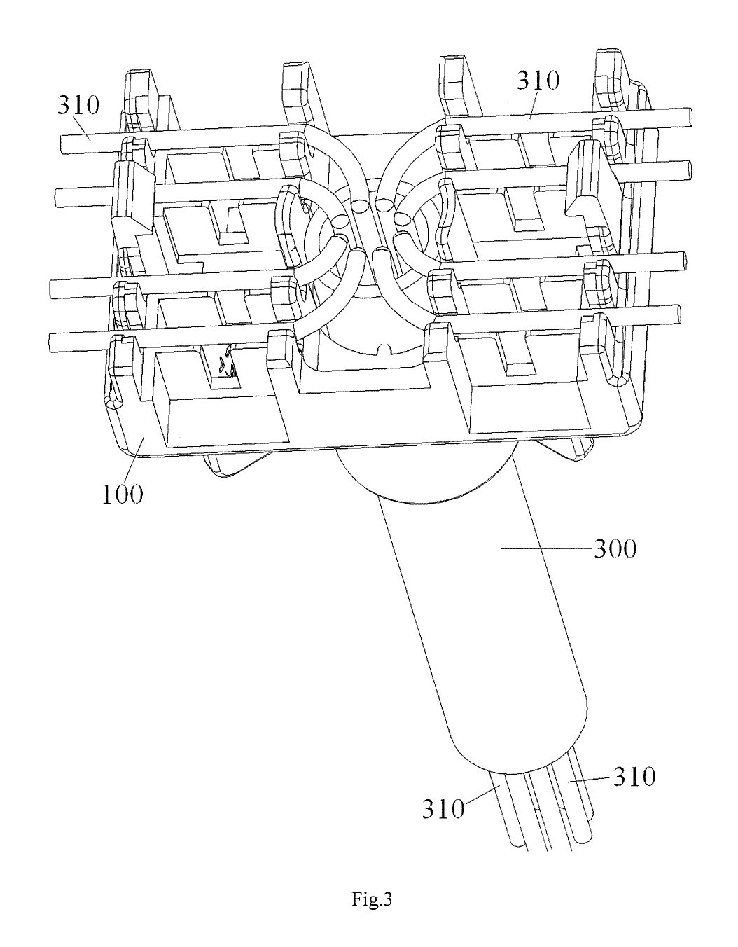

FIG. 3 is an illustrative view showing that cable cores 310 of a communication cable 300 are positioned in the first termination portion 110 of the dust cover of FIG. 2.

As shown in FIGS. 1-3, the communication cable 300 is fixed on the dust cover 100. The cable cores 310 of the communication cable 300 are arranged in the first termination portion 110 of the dust cover 100.

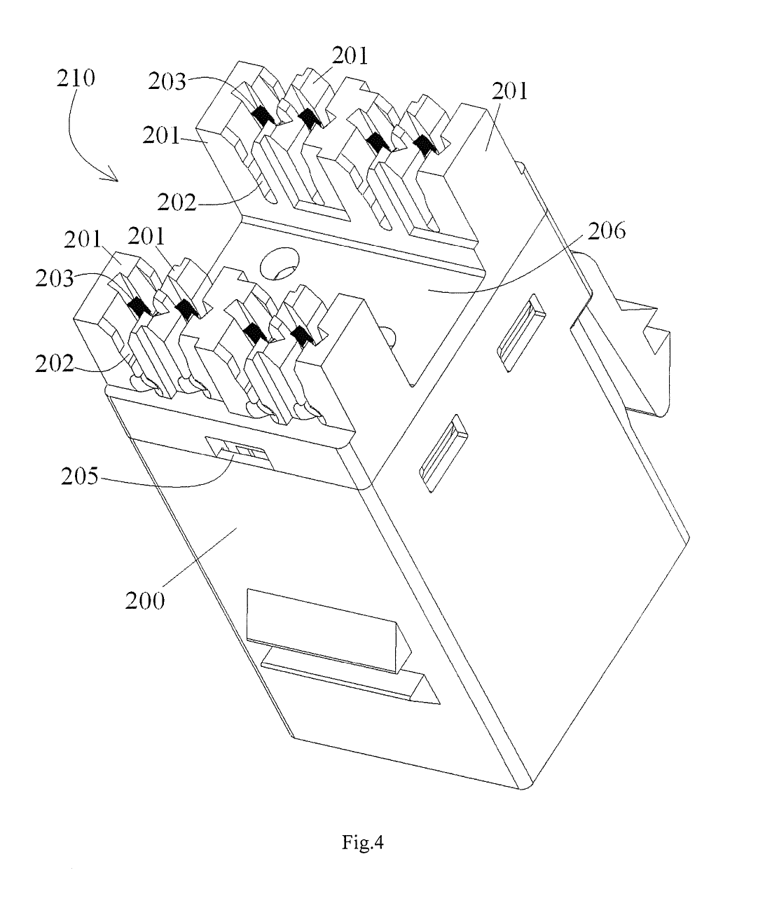

FIG. 4 is an illustrative perspective view of a communication module 200 of a communication cable termination assembly according to an exemplary embodiment of the present invention.

As shown in FIG. 4, the communication module 200 comprises a second termination portion 210 located at an end thereof. The first and second termination portions 110, 210 are configured to be capable of being press-fitted together.

Please refer to FIG. 4 again, the communication module 200 comprises metal pieces 203 for electrically connecting to the cable cores 310 of the communication cable 300. When the dust cover 100 is press-fitted onto the communication module 200, the metal piece 203 each pierces an outer insulation layer of the respective cable core 310 to electrically contact with an inner conductor of the cable core 310 so as to build an electrical connection between the communication module 200 and the communication cable 300.

As shown in FIGS. 1-3, the dust cover 100 has a center hole 121 passing through the cable fixation portion 120 and the cover plate 130, and the communication cable 300 is introduced into the dust cover 100 through the center hole 121.

In an exemplary embodiment, as shown in FIGS. 1-3, the cable fixation portion 120 has a truncated cone shape adapted to be crimped on the communication cable 300. With this structure, the communication cable 300 may be easily fixed on the dust cover 100.

As shown in FIGS. 2-3, the first termination portion 110 has at least one cable positioning and clamping features comprising: a projection wall 113 having a first end proximal to the center hole 121 and a second end opposite to the first end; a positioning slot 115 formed near the first end of the projection wall 113; and a clamping slot 114 formed near the second end of the projection wall 113.

As shown in FIG. 3, the cable core 310 introduced into the dust cover 100 through the center hole 121 is positioned in the positioning slot 115, runs over the top of the projection wall 113, and is clamped in the clamping slot 114.

As shown in FIG. 4, a groove 202 is formed in the second termination portion 210 of the communication module 200. The projection wall 113 may be press-fitted into the groove 202.

As shown in FIG. 3, the communication cable 300 is a multi-core communication cable comprising a plurality of cable cores 310. As shown in FIG. 2, the first termination portion 110 comprises a plurality of cable positioning and clamping features corresponding to the plurality of cable cores 310, respectively.

As shown in FIGS. 1-3, the plurality of cable positioning and clamping features are symmetrically arranged at both sides of the center hole 121. The positioning slot 115 for positioning the cable core 310 is formed in a first protrusion wall 112, which is substantially perpendicular to the projection wall 113, near the first end of the projection wall 113. The clamping slot 114 is formed in a second protrusion wall 111, which is substantially perpendicular to the projection wall 113, near the second end of the projection wall 113.

As shown in FIGS. 1-3, the outer insulation layers of the plurality of cable cores 310 have different colors from one another. A vision mark portion 150 is formed on an outer surface of the cover plate 130 and has a plurality of color marking sections corresponding to the colors of outer insulation layers of the plurality of cable cores 310. The plurality of color marking sections are positioned at positions corresponding to the plurality of cable positioning and clamping features, respectively. With such configuration, the plurality of cable cores can be correctly arranged in the plurality of cable positioning and clamping features, respectively.

As shown in FIGS. 2-3, a notch 116 is formed in the projection wall 113 of the first termination portion 110. As shown in FIG. 4, the metal piece 203 is formed in the groove 202 of the second termination portion 210 and corresponds to the respective notch 116. When the projection wall 113 of the first termination portion 110 is press-fitted into the groove 202 of the second termination portion 210, a tip of the metal piece 203 moves toward the notch 116 and pierces the outer insulation layer of the cable core 310 located on the projection wall 113, and a bent portion of the cable core 310 resulted from the metal piece 203 is pushed into the notch 116.

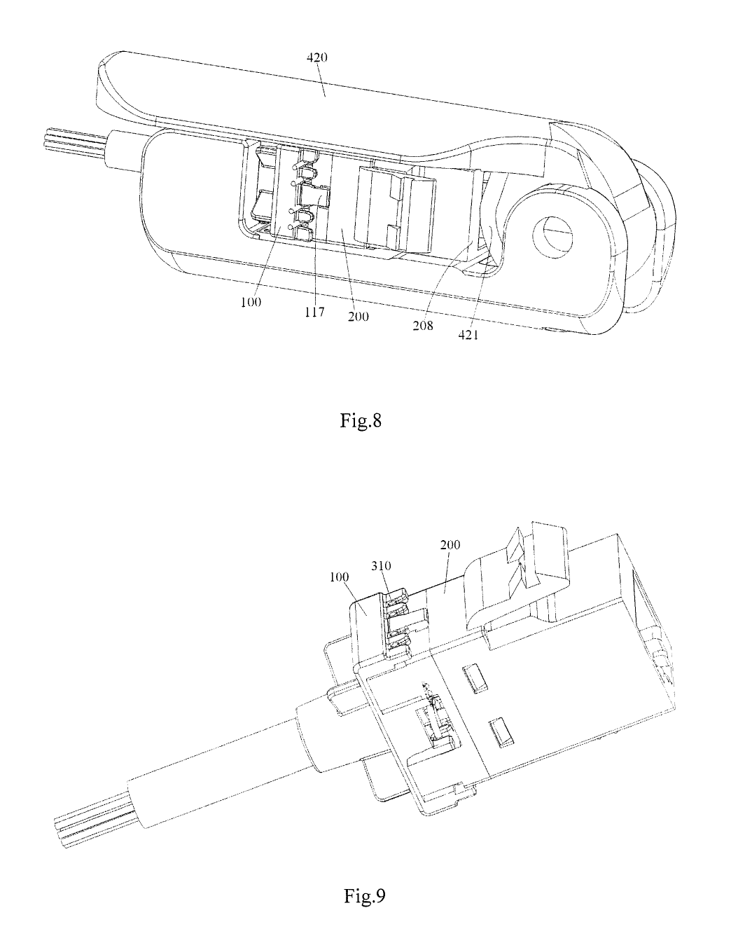

As shown in FIG. 2, the first termination portion 110 further comprises a hook 117, and the second termination portion 210 further comprises a recess 205 for matching with the hook 117. As shown in FIGS. 8-9, when the first termination portion 110 is press-fitted onto the second termination portion 210, the hook 117 is snapped into the recess 205 to lock the first and second termination portions 110, 210 together.

As shown in FIG. 4, the second termination portion 210 comprises two rows of projection vertical walls 201, and the groove 202 is defined between two adjacent vertical walls 201.

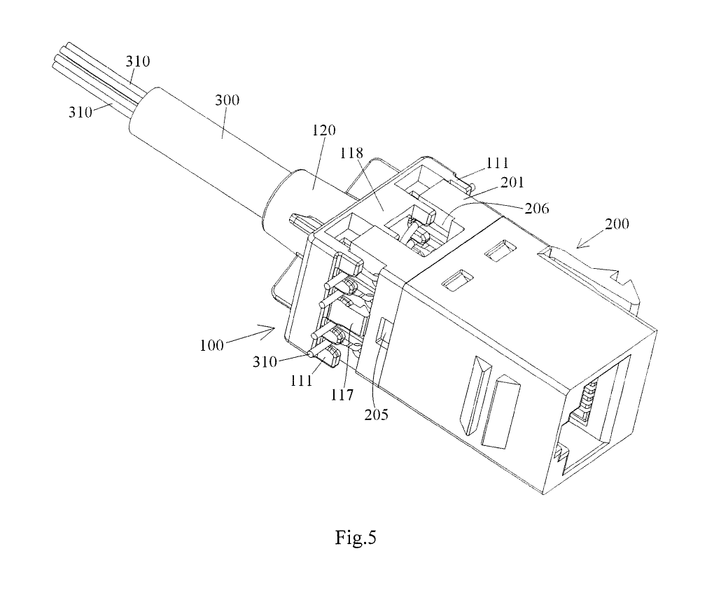

FIG. 5 is an illustrative perspective view showing that the dust cover 100 of FIG. 3 is pre-aligned and pre-assembled to the communication module 200 of FIG. 4.

As shown in FIGS. 3-5, the vertical walls 201 of the second termination portion 210 are configured to be received in recesses defined among the projection walls 113 and the first and second protrusion walls 112, 111 of the first termination portion 110.

As shown in FIGS. 1-5, the first termination portion 110 further comprises a guide wall 118 substantially perpendicular to the first protrusion walls 112, and the second termination portion 210 further comprises a guide groove 206 between the two rows of vertical walls 201. The guide groove 206 is configured to match with the guide wall 118 so as to guide the first termination portion 110 to be correctly press-fitted onto the second termination portion 210.

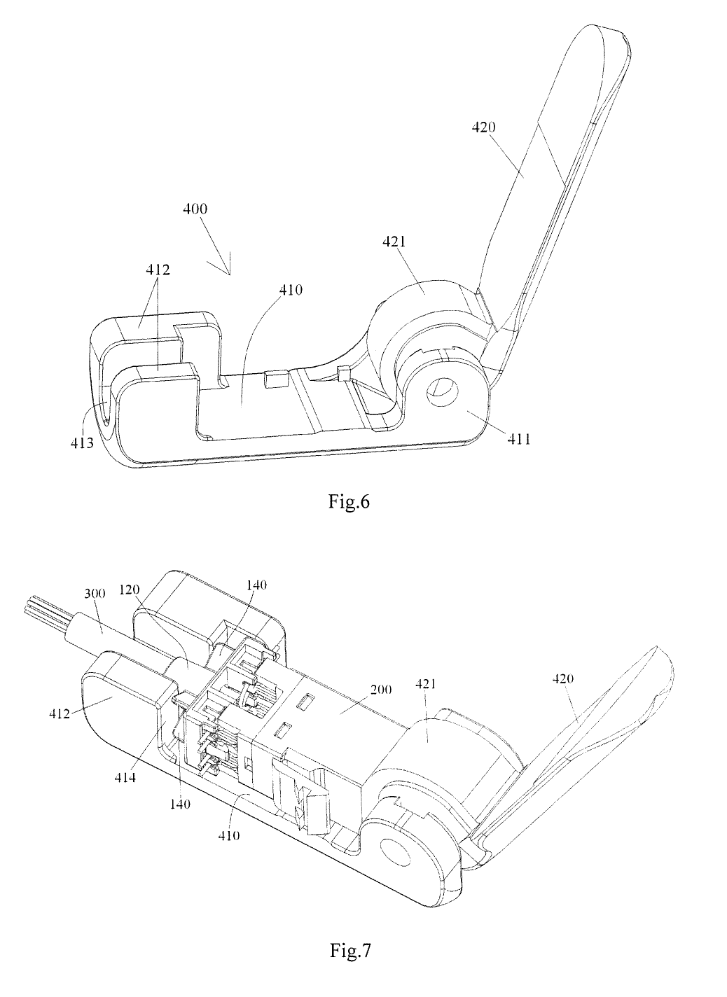

FIG. 6 is an illustrative perspective view of a tool for press-fitting the dust cover 100 onto the communication module 200.

As shown in FIG. 6, the tool mainly comprises a base plate 410 having a first end and a second end opposite to the first end, a handle 420 having an arc end portion 421 rotatably connected to the first end of the base plate 410, and a block portion 412 formed on the second end of the base plate 410 and having a channel passing therethrough.

FIG. 7 is an illustrative view showing that the pre-aligned dust cover 100 and communication module 200 are placed in the tool of FIG. 6.

As shown in FIG. 7, after being pre-aligned, the dust cover 100 and the communication module 200 are placed on the base plate 410 between the arc end portion 421 and the block portion 412 with the communication cable 300 passing through the channel 413 of the block portion 412.

FIG. 8 is an illustrative view showing that the dust cover 100 and the communication module 200 are press-fitted together by operating the tool of FIG. 6.

As shown in FIG. 8, when rotating the handle 420 downward, the arc end portion 421 pushes against the communication module 200 until that the dust cover 100 and the communication module 200 are press-fitted together and that the hook 117 is snapped into the recess 205 to lock the first and second termination portions 110, 210 together.

As shown in FIGS. 1-7, a plurality of vertical reinforcing ribs 140 are formed on the outer surface of the dust cover 100, the plurality of vertical reinforcing ribs 140 surrounding and being connected to the cable fixation portion 120. As shown in FIGS. 7-8, the block portion 412 of the tool presses against the vertical reinforcing ribs 140 of the dust cover 100 to protect the dust cover 100 from being collapsed during press-fitting the dust cover 100 and the communication module 200.

Hereafter, it will describe in detail the assembling method of the communication cable termination assembly with reference to FIGS. 1-8. The method mainly comprises steps of:

introducing the communication cable 300 into the dust cover 100 and fixing the communication cable 300 to the dust cover 100, as shown in FIG. 3;

positioning the cable cores 310 on the dust cover 100, as shown in FIG. 3;

pre-aligning the dust cover 100 and the communication module 200, as shown in FIG. 5;

placing the pre-aligned dust cover 100 and communication module 200 in the tool, as shown in FIG. 7; and

operating the tool to press-fit the dust cover 100 onto the communication module 200, as shown in FIG. 8.

FIG. 9 is an illustrative perspective view of the assembled communication cable termination assembly of FIG. 8.

In an exemplary embodiment, the above method may further comprise: trimming off end parts of the cable cores 310 extending beyond the dust cover 100 after press-fitting the dust cover 100 onto the communication module 200.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle, so that more kinds of communication cable termination assembly can be achieved with overcoming the technical problem of the present invention.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A communication cable termination assembly, comprising:
a communication module; and
a dust cover capable of being press-fitted onto the communication module,
wherein a communication cable is fixed on the dust cover and has at least one cable cores disposed between the dust cover and the communication module,
wherein the communication module comprises at least one metal pieces for electrically connecting to the cable cores of the communication cable, respectively,
when the dust cover is press-fitted onto the communication module, the metal pieces pierce outer insulation layers of the cable cores, respectively, to electrically contact with an inner conductor of the cable core so as to build an electrical connection between the communication module and the communication cable.

2. The communication cable termination assembly according to claim 1,
wherein the dust cover comprising:
a cover plate;
a cable fixation portion located outside the cover plate; and a first termination portion located inside the cover plate,
wherein the communication module comprising:
a second termination portion located at an end thereof,
wherein the first and second termination portions are configured to be capable of being press-fitted together.

3. The communication cable termination assembly according to claim 2,
wherein the dust cover has a center hole passing through the cable fixation portion and the cover plate; and
wherein the communication cable is introduced into the dust cover through the center hole.

4. The communication cable termination assembly according to claim 3, wherein the cable fixation portion has a truncated cone shape adapted to be crimped on the communication cable.

5. The communication cable termination assembly according to claim 4,
wherein the first termination portion has a cable positioning and clamping feature comprising:
a projection wall having a first end proximal to the center hole and a second end opposite to the first end;
a positioning slot formed near the first end of the projection wall; and
a clamping slot formed near the second end of the projection wall, wherein the cable core introduced into the dust cover through the center hole is positioned in the positioning slot, runs over the top of the projection wall, and is clamped in the clamping slot; and
wherein the second termination portion comprising a groove into which the projection wall is to be press-fitted.

6. The communication cable termination assembly according to claim 5, wherein the communication cable is a multi-core communication cable comprising a plurality of cable cores; and
wherein the first termination portion comprises a plurality of cable positioning and clamping features corresponding to the plurality of cable cores, respectively.

7. The communication cable termination assembly according to claim 6,
wherein the plurality of cable positioning and clamping features are symmetrically arranged at both sides of the center hole;
wherein the positioning slot is formed in a first protrusion wall, which is substantially perpendicular to the projection wall, near the first end; and
wherein the clamping slot is formed in a second protrusion wall, which is substantially perpendicular to the projection wall, near the second end.

8. The communication cable termination assembly according to claim 6,
wherein the outer insulation layers of the plurality of cable cores have different colors from one another; and
wherein a vision mark portion is formed on an outer surface of the cover plate and has a plurality of color marking sections corresponding to the colors of outer insulation layers of the plurality of cable cores, the plurality of color marking sections are positioned at positions corresponding to the plurality of cable positioning and clamping features, respectively.

9. The communication cable termination assembly according to claim 8,
wherein a notch is formed in the projection wall of the first termination portion;
wherein the metal piece is formed in the groove of the second termination portion and corresponds to the notch; and
when the projection wall of the first termination portion is press-fitted into the groove of the second termination portion, a tip of the metal piece moves toward the notch and pierces the outer insulation layer of the cable core.

10. The communication cable termination assembly according to claim 9,
wherein the first termination portion further comprises a hook, and the second termination portion further comprises a recess for matching with the hook; and
when the first termination portion is press-fitted onto the second termination portion, the hook is snapped into the recess to lock the first and second termination portions together.

11. The communication cable termination assembly according to claim 10,
wherein the second termination portion comprises two rows of projection vertical walls; and
wherein the groove is defined between two adjacent vertical walls.

12. The communication cable termination assembly according to claim 11,
wherein the vertical walls of the second termination portion are configured to be received in recesses defined among the projection walls and the first and second protrusion walls of the first termination portion.

13. The communication cable termination assembly according to claim 12,
wherein the first termination portion further comprises a guide wall substantially perpendicular to the first protrusion walls; and
wherein the second termination portion further comprises a guide groove between the two rows of vertical walls, and the guide groove is configured to match with the guide wall so as to guide the first termination portion to be correctly press-fitted onto the second termination portion.

14. A tool for press-fitting the dust cover onto the communication module of the communication cable termination assembly according to claim 1.

15. The tool according to claim 14, comprising:
a base plate having a first end and a second end opposite to the first end;
a handle having an arc end portion rotatably connected to the first end of the base plate; and
a block portion formed on the second end of the base plate and having a channel passing therethrough,
wherein after being pre-aligned, the dust cover and the communication module
are placed on the base plate between the arc end portion and the block portion with the communication cable passing through the channel of the block portion; and
wherein the arc end portion pushes against the communication module until the dust cover and the communication module are press-fitted together by rotating the handle.

16. The tool according to claim 15,
wherein a plurality of vertical reinforcing ribs are formed on the outer surface of the dust cover, the plurality of vertical reinforcing ribs surrounding and being connected to the cable fixation portion; and
wherein the block portion of the tool presses against the vertical reinforcing ribs of the dust cover during press-fitting the dust cover and the communication module.

17. A method for assembling the communication cable termination assembly according to claim 1, comprising steps of:
introducing the communication cable into the dust cover and fixing the communication cable to the dust cover;
positioning the cable cores on the dust cover;
pre-aligning the dust cover and the communication module;
placing the pre-aligned dust cover and communication module in a tool; and operating the tool to press-fit the dust cover onto the communication module.

18. The method according to claim 17, further comprising:
trimming off end parts of the cable cores extending beyond the dust cover after press-fitting the dust cover onto the communication module.

19. The method according to claim 17, wherein the tool is defined claim 14.

20. The method according to claim 17, wherein the tool is defined by claim 15.

21. The method according to claim 17, wherein the tool is defined by claim 16.
